(19) United States
(12) Patent Application Publication
(10) Pub. No.: US 2016/0267526 A1
(43) Pub. Date: Sep. 15, 2016

(54) MULTI-TOUCH ATTRIBUTION

(71) Applicant: Facebook, Inc., Menlo Park, CA (US)

(72) Inventors: Liang Xu, Bellevue, WA (US); Aleksey Sergeyevich Fadeev, Seattle, WA (US); Cheng-huan Sean Chu, Stanford, CA (US); Xiao Zhang, Mountain View, CA (US)

(21) Appl. No.: 14/644,200

(22) Filed: Mar. 10, 2015

(51) Int. Cl. G06Q 30/02

(52) U.S. Cl. CPC G06Q 30/0246; G06Q 30/0277

(57) ABSTRACT

An advertiser determines an attribution assigned to an online publisher for providing advertisement impressions to a user that purchased the product associated with the advertisement impressions. An event chain that resulted in a conversion by a user is received and a probability that the event chain would result in a conversion is determined. A probability that a second event chain that includes the events of the received event chain except for a target event, would result in a conversion is determined. A score for the target event is determined based on the probability that the received event chain would result in a conversion and the probability that the second event chain would result in a conversion.

### BACKGROUND

This disclosure relates generally to online advertising, and more specifically to dividing attribution for a conversion event across advertisement impressions to a user of an online system.

Online advertisement publishers present advertisements to users of online systems, commonly referred to as advertising impressions. A user may be presented with multiple advertisements (or the same advertisement multiple times) for a specific product, service, etc. before deciding to take an action relating to the advertisement, such as making a purchase of the advertised product. Each of those advertisement impressions may have an influence on the final decision by the user to take that action or purchase the product.

For instance, an advertisement impression may result in a user clicking on the advertisement such that the user is taken to a landing page that guides the user on through the purchasing process (e.g., the landing page may be an online marketplace that includes controls for user to place the product into an online shopping cart). In this scenario, the advertiser can readily know that this advertisement impression and the associated online advertisement publisher that provided the advertisement impression influenced the user into purchasing the product (i.e., that resulted in an advertisement conversion).

However, other online publishers may have also provided advertisement impressions to the user that purchased the product and those advertisement impressions may have had an influence on the user's decision to purchase. Additionally, the advertisement impressions may have been provided to the user via multiple client devices, such as, a home computer, a work computer, or a handheld mobile device.

Further, different advertisement impressions may have a different impact or influence on the decision of the user to purchase the product. For instance, an advertisement impression shown on a handheld mobile device may have a different influence on the user's decision to purchase the product than an advertisement impression show on a home computer. Similarly, an advertisement impression shown during work hours may have a different influence on the user's decision to purchase the product than an advertisement impression shown at night after the user has left their workplace. Thus, an advertiser may want to appropriately attribute the conversion across all of these impression events that resulted in the user purchasing a product associated with the advertisement impression, and preferably may wish to assign attribution proportionally to the amount of influence the advertisement impression(s) provided by the advertisement publishers had on the decision by the user to purchase the product. This information allows the advertiser to gain insights into his campaign, such as which advertising channels are most successful in producing conversions and/or help the advertiser make decisions on the budget allocation across online publishers.

### SUMMARY

Attribution for an advertisement conversion determined based on information associated with advertisement impressions provided by one or more advertisement publishers. An advertisement system may determine a score for advertisement impressions indicative of the influence the advertisement impression had on the decision of a user to take some action, such as purchasing a product, associated with the advertisement impression. The advertisement system receives information about an advertisement conversion event for a user and a number of advertisement impressions for that same user associated with that conversion event. The advertisement impressions thus make up an event chain that leads up to the conversion.

For instance, based on a model, a probability that a first event chain that includes multiple events, each representing different advertisement impressions provided to a user by multiple advertisement publishers, would result in a conversion by the user (e.g., a purchase of a product associated with the advertisement impressions) is determined. Additionally, based on the same model, a probability that a second event chain that includes a subset of events of the first event chain (e.g., the second event chain including every event of the first event chain except for a target event) would result in a conversion by the user is determined. A score is then determined based on the determined probabilities that the first event chain and the second event chain would result in conversions by the user. The attribution amount or portion of the credit for a conversion that is assigned to an impression provided by a publisher (e.g., a publisher that presented an advertisement impression associated with the target event that was excluded from the second event chain) is determined based on the determined score.

The advertisement impressions may be provided to the user via multiple client devices (e.g., a home computer, a work computer, and a handheld mobile device). The advertisement system may identify advertisement impressions that were sent to the user and assign an attribution credit amount to the impression that influenced the user to take the action (e.g., purchase the product or service, etc.) associated with the advertisement impressions instead of only attributing the conversion to the last impression that resulted in the purchase of the product.

The model used to determine the probability that an event chain would result in a conversion may take into account multiple characteristics associated with each of the events in the chain, such as, characteristics of the user that purchase the product, time of the day the advertisement impression was presented the user, type of mobile device in which the advertisement impression was presented, size of the advertisement impression, etc.

### BRIEF DESCRIPTION OF THE DRAWINGS

FIG. 1 is a block diagram of a system environment in which a social networking system operates, in accordance with an embodiment.

FIG. 2 is a block diagram of a social networking system, in accordance with an embodiment.

FIG. 3 is a block diagram of an advertisement module, in accordance with an embodiment.

FIG. 4 is a flow chart of a method for attributing credit for a conversion across advertisement impressions, in accordance with an embodiment.

FIGS. 5A and 5B are examples of event chains used to determine the attribution assigned to advertisement impressions provided to users, according to embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

System Architecture

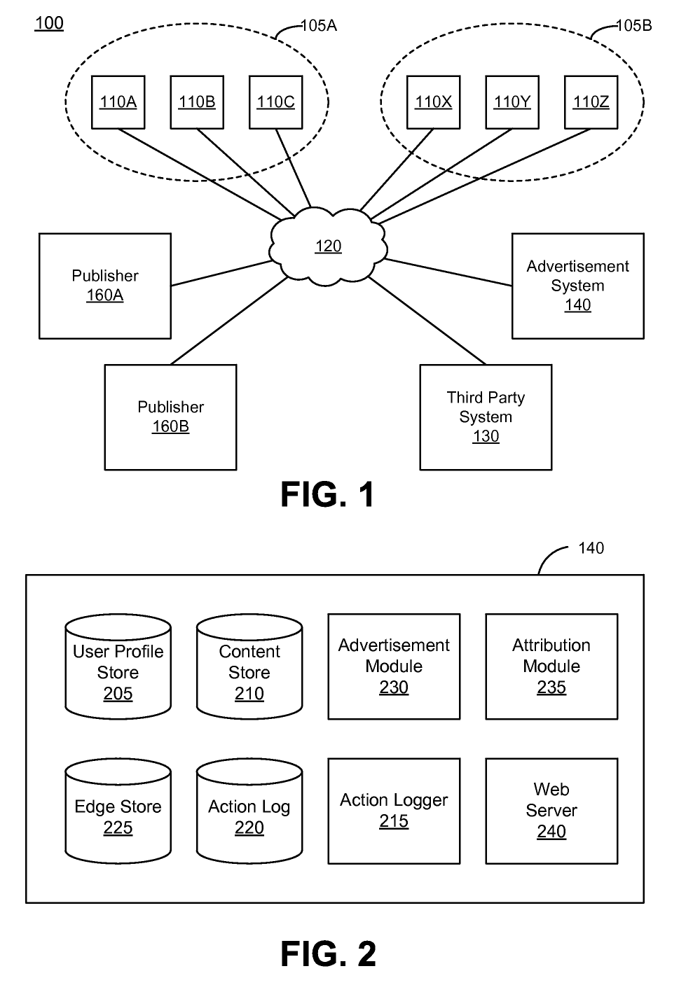

FIG. 1 is a block diagram of a system environment 100 for an advertising system 140. The system environment 100 shown by FIG. 1 comprises one or more users 105, each user one or more client devices 110, a network 120, one or more publishers 130, and the advertising system 140. In alternative configurations, different and/or additional components may be included in the system environment 100. Further, the embodiments described herein can be adapted to online systems that are not advertising systems. For the purposes of this description, a social networking system is often used as an example of an advertising system, though this is not intended to be limiting in any way.

The client devices 110 are one or more computing devices capable of receiving user input as well as transmitting and/or receiving data via the network 120. One user 105 may be associated with multiple client devices 110. For example, in FIG. 1, user 105A is associated with three client device 110A, 110B, and 110C, and user 105B is associated with three client devices 110X, 110Y, and 110Z. The multiple client devices may be associated with one user after the user enters user credentials for a user account into each of the client devices. That is, client devices 110A, 110B, and 110C are associated with user 105A after user 105A enters user credentials for the same user account into client devices 110A, 110B, and 110C.

In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the social networking system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the social networking system 140, such as advertisements, content, or information about an application provided by the third party system 130.

A publisher 160 is an entity that displays a content item to a user. The publisher 160 may include, for example, a service provider such as a newspaper, a video content provider, a web retailer, an email service provider, or a social networking system. Examples of online publishers 160 include FACEBOOK®, GOOGLE®, YAHOO®, etc. In one embodiment, the publisher 160 receives a content item provided by the social networking system 140. In other embodiments, the publisher 160 receives a content item provided by an advertisement exchange server (not shown). The publisher 160 displays the received content item to the user.

FIG. 2 is a block diagram of an architecture of the advertising system 140. As explained above, a social networking system is used as an example of an advertising system and is illustrated in FIG. 2. Though there can be other advertising systems as well. In such a case, the advertising system may not include certain of the social networking components, such as an edge store 220, and the components may be otherwise modified to fit that system. The social networking system 140 shown in FIG. 2 includes a user profile store 205, a content store 210, an action logger 215, an action log 220, an edge store 225, an advertisement (“ad”) module 230, a attribution module 235 and a web server 240. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture.

Each user of the social networking system 140 is associated with a user profile, which is stored in the user profile store 205. A user profile includes declarative information about the user that was explicitly shared by the user and may also include profile information inferred by the social networking system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the social networking system 140, user profiles may also be stored for entities such as businesses or organizations. This allows an entity to establish a presence on the social networking system 140 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

Conventional advertising systems do not have access to the actual user identity for users of the system, but instead use cookies to track users, which may only identify the device and/or browser, and not necessarily the identity of the user. Here, however, the advertising system 140 has access to the actual user identity for users of the system, in some embodiments. The advertising system 140 can use a user identifier that links the user to his user profile in the user profile store 205. For example, where the advertising system 140 is or is connected to a social networking system, the system knows the identity of its users if the user is logged into the system, and thus can link actions taken as a user is navigating the Internet to the particular user, and can link the user to his social networking user profile. In other embodiments, the advertising system 140 may not have direct access to the user identity, but may acquire it by partnering or otherwise sharing information with a system that tracks identity, such as a social networking system. In one example, an advertising system 140 uses cookies to track its users, and partners with a social networking system or other system having access to user identity tracked via a user identifier. The social networking system hashes or otherwise encrypts its user identifier and provides the hashed ID to the advertising system or writes the hashed ID into a cookie used by the advertising system 140 such that the advertising system 140 can track user identity. In another example in which the advertising system 140 uses cookies to track its users, the advertising system 140 applies a method via which the cookie is correlated with a user identifier used by another system, such as a social networking system, such that the identity of the user can be determined. An example of this type of correlation is further explained in U.S. application Ser. No. 14/641,256, filed on Mar. 6, 2015, which is hereby incorporated by reference herein in its entirety. Thus, in some cases, the identity stored is an identity obtained via this correlation.

The content store 210 stores objects in which each object may represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 210, such as status updates, photos tagged by users to be associated with other objects in the social networking system, events, groups or applications. In some embodiments, objects are received from third-party applications or third-party applications separate from the social networking system 140. In one embodiment, objects in the content store 210 represent single pieces of content, or content “items.” Hence, social networking system users are encouraged to communicate with each other by posting text and content items of various types of media to the social networking system 140 through various communication channels. This increases the amount of interaction of users with each other and increases the frequency with which users interact within the social networking system 140.

The action logger 215 receives communications about user actions internal to and/or external to the social networking system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the social networking system 140 to track user actions on the social networking system 140, as well as actions on third party systems 130 that communicate information to the social networking system 140. Users may interact with various objects on the social networking system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the social networking system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the social networking system 140 as well as with other applications operating on the social networking system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the social networking system 140. For example, an e-commerce website may recognize a user of a social networking system 140 through a social plug-in enabling the e-commerce website to identify the user of the social networking system 140. Because users of the social networking system 140 are uniquely identifiable, e-commerce websites, such as in the preceding example, may communicate information about a user's actions outside of the social networking system 140 to the social networking system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page on the social networking system 140, sharing a link with other users of the social networking system 140, and commenting on posts made by other users of the social networking system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the social networking system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the social networking system 140 over time to approximate a user's interest in an object or another user in the social networking system 140 based on the actions performed by the user. A user's affinity may be computed by the social networking system 140 over time to approximate a user's interest for an object, interest, or other user in the social networking system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The ad module 230 stores information describing advertisement (“ad”) campaigns received from one or more advertisers. An advertising campaign includes one or more ad requests that each describe advertisements in the advertising campaign for presentation to one or more social networking system users. An ad request includes advertisement content, which is text, image, audio, video, or any other suitable data presented to a user. In various embodiments, the advertisement content is associated with a network address specifying a landing page, or other destination, to which a user is directed when the advertisement is accessed. An ad request also associates a bid amount with an advertisement. In some embodiments, the bid amount is specified by an advertiser and is used to determine an expected value, such as monetary compensation, provided by an advertiser to the social networking system 140 if the advertisement is presented to a user, if the advertisement receives a user interaction, or based on any other suitable condition. For example, the bid amount specifies a monetary amount that the social networking system 140 receives from the advertiser if the advertisement is displayed and the expected value is determined by multiplying the bid amount by a probability of the advertisement being accessed.

Additionally, an ad request may include one or more targeting criteria specified by the advertiser. Targeting criteria included in an ad request specify one or more characteristics of users eligible to be presented with advertisement content associated with the ad request. For example, targeting criteria are used to identify users having user profile information, edges or actions satisfying at least one of the targeting criteria. Hence, targeting criteria allow an advertiser to identify users having specific characteristics, simplifying subsequent distribution of ad content to different users. Additionally, targeting criteria may be associated with an advertising campaign in its entirety, so multiple advertisements in the advertising campaign are eligible to users having characteristics satisfying one or more of the targeting criteria associated with the advertising campaign.

In one embodiment, targeting criteria may specify actions or types of connections between a user and another user or object of the social networking system 140. Targeting criteria may also specify interactions between a user and objects performed external to the social networking system 140, such as on a third party system 130. For example, targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in targeting criteria allows advertisers to further refine users eligible to be presented with ad content in an ad request that includes the targeting criteria. As another example, targeting criteria identifies users having a connection to another user or object or having a particular type of connection to another user or object.

The ad module 230 retrieves advertisements from one or more advertising campaigns and ranks the received advertisements based on their associated bid amounts when an opportunity to present an advertisement to a user is identified. For example, the ad module 230 ranks the received advertisements based on their associated expected values, which are based at least in part on advertisements' bid amounts, where advertisements associated with larger expected values have a higher position in the ranking. The ad module 230 selects one or more advertisements based on the ranking, and the selected advertisements are presented to a social networking system user. For example, the ad module 230 selects advertisements having the highest position in the ranking or having at least a threshold position in the ranking. In other embodiments, the ad module 230 may use any other suitable method to select advertisements for presentation to a social networking system user.

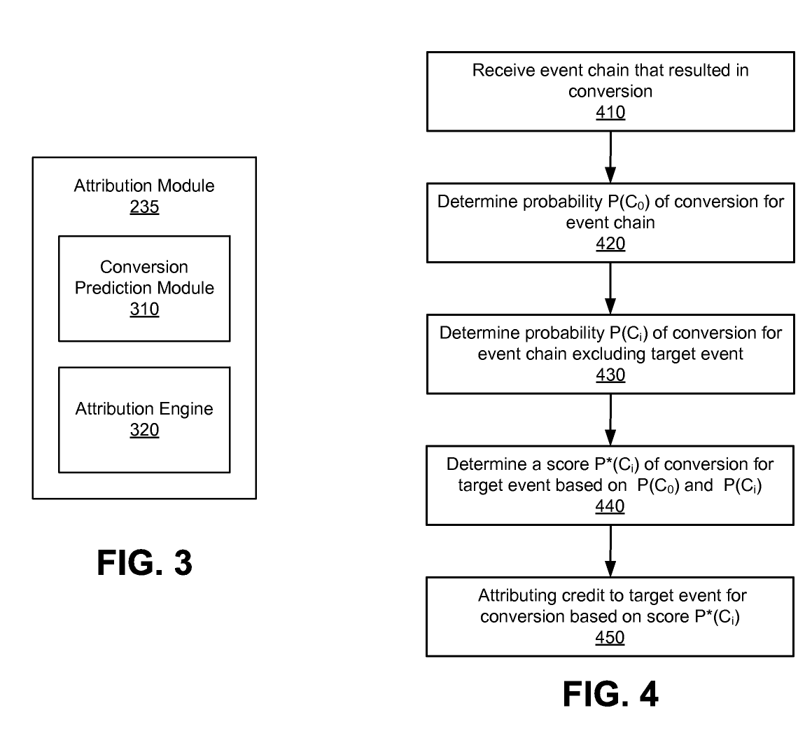

The attribution module 235 determines an attribution amount or fractional credit to assign to advertisement impressions presented by publishers to users that resulted in a conversion. In some embodiments, the attribution module 235 determines an attribution amount or credit to assign to advertisement impressions after the user has performed a certain action. For instance, the attribution module 235 determines an attribution amount or credit to assign to an advertisement impression associated with a product that was presented to a user that bought the product. As illustrated in FIG. 3, the attribution module 235 includes the conversion prediction module 310 and the attribution engine 320.

In some embodiments, the attribution module 235 determines an attribution amount or portion of the credit to assign to a publisher for all the advertisement impressions that the advertiser presented to a user that resulted in a conversion.

The conversion prediction module 310 determines a probability that an event chain would result in a conversion. An event, for instance, includes the presentation of an advertisement to a user by a publisher (e.g., an advertisement impression from a publisher to a user via a client device). Events have associated multiple properties. For instance, events may be associated with a publisher, a product, a date/time, a user device, a user location, etc. An event chain is a set of multiple events with one or more properties in common. For instance, an event chain may include advertisements associated with a specific product presented to a specific user within a specified time period.

The conversion prediction module 310 determines a probability of a user to perform an action (e.g., purchase a product) based on the properties of each event of an event chain. In some embodiments, the conversion prediction module 310 is trained based on previous event chains. For instance, the conversion prediction module 310 is trained on event chains within the past year. In some embodiments, a different model is generated for each product or group of products. In other embodiments, a different model is generated for each user or group of users. In yet other embodiments, a single model that takes into consideration characteristics of the products and characteristics of the users is generated.

The attribution engine 320 determines an attribution amount or portion of the credit for a conversion to assign to an advertisement impression based on a probability determined by the conversion prediction module 310. For instance, the attribution engine 320 determines a score for an advertisement impression based on a determined probability for an event associated with the advertisement impression.

The attribution engine 320 may also determine an attribution amount to assign to a publisher based on a probability determined by the conversion prediction module 310. For instance, the attribution engine 320 determines a score based on the determined probability for each event associated with a publisher, and an attribution amount is determined for the publisher based on the determined score.

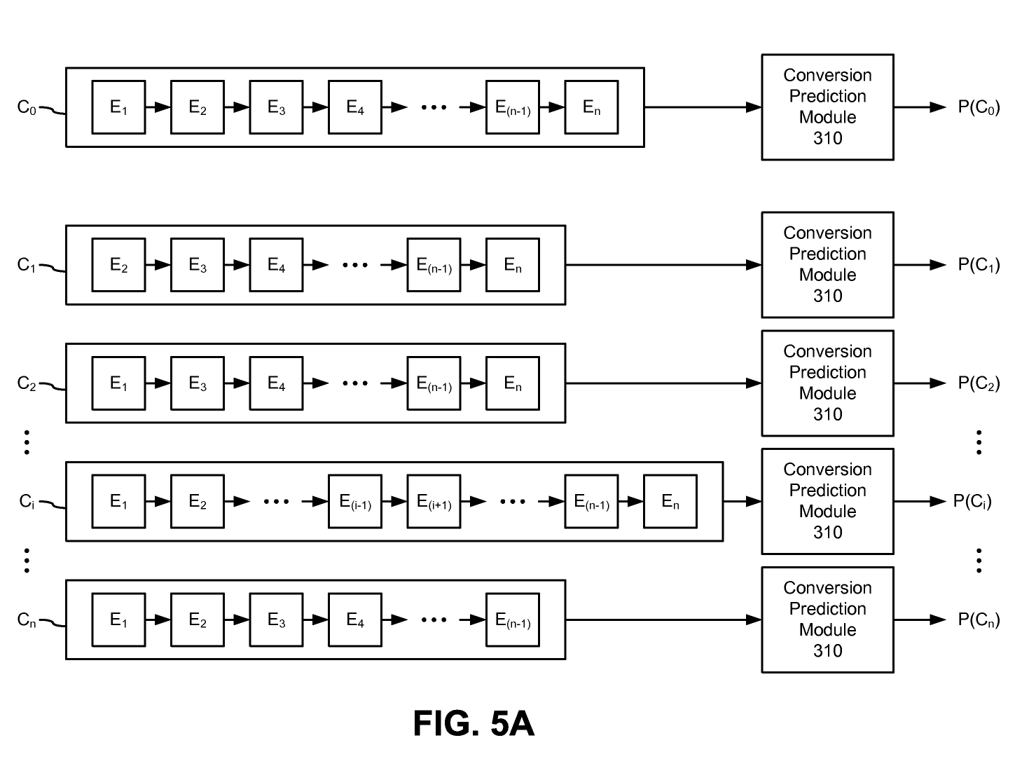

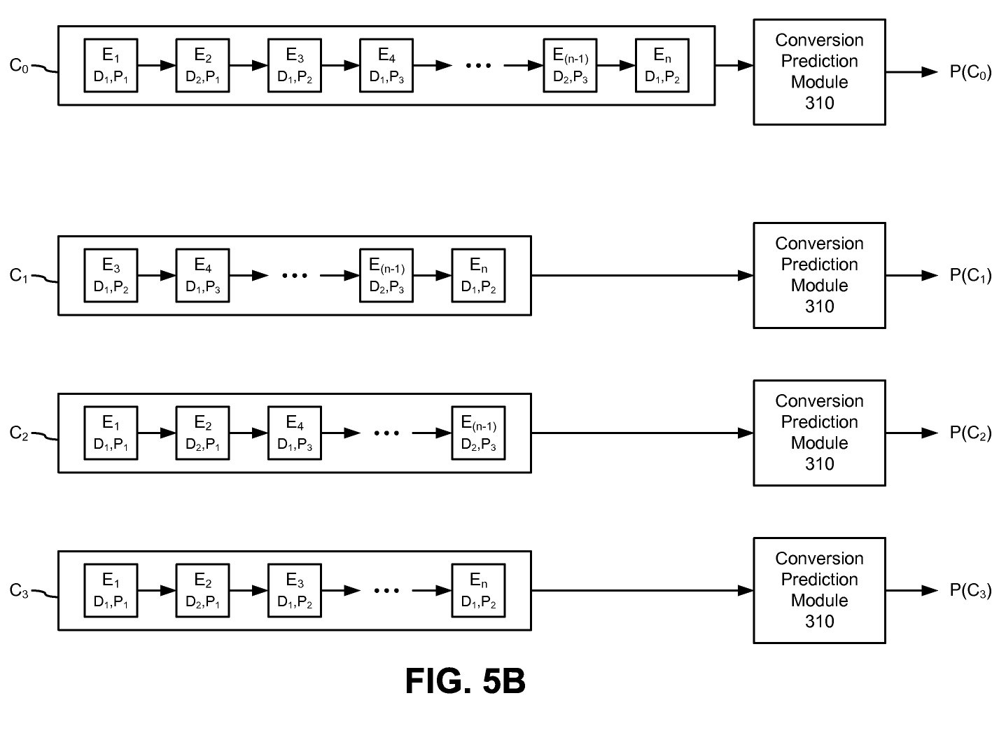

FIG. 4 illustrates a flow diagram of a process for attributing a portion of the credit for a conversion to an advertisement impression presented by a publisher or for determining an attribution amount to assign to the publisher. FIG. 5A illustrates a box diagram of an exemplary embodiment of a process for determining an attribution amount to assign to an advertisement impressions, and 5B illustrates a box diagram of an exemplary embodiment of a process for determining an attribution amount to assign to a publisher that presented and advertisement to a user that purchased a product associated with the advertisement impression.

The attribution module 235 receives 410 an event chain that resulted in a conversion by a user. FIG. 5A illustrates a sample event chain C₀ that includes n events E₁, E₂, E₃, E₄, . . . , E₍ₙ₋₁₎, Eₙ. For instance, each event E₁ to Eₙ of event chain C₀ is an advertisement for a product P sent to user 105A via one of the user's client devices 110A, 110B, and 110C. The advertisements associated with events E₁ to Eₙ may be presented to user 105A by multiple publishers 160A, 160B or by the same publisher.

The conversion prediction module 310 determines 420 the probability that event chain C₀ would result in a conversion. As illustrated in FIGS. 5A and 5B, the conversion prediction module 310 determines probability P(C₀) that event chain C₀ would result in a conversion by user 105A.

The conversion prediction module 310 determines 430 the probability that an event chain Cᵢ that includes a subset of events of chain C₀. For instance, the conversion prediction module 310 determines the probability P(Cᵢ) that an event chain Cᵢ that includes every event except for the i-th event Eᵢ would result in a conversion by user 105A, as illustrated in FIG. 5A. In another example, the conversion prediction module 310 determines the probability P(Cᵢ) that an event chain Cᵢ that includes every event except for the event associated with advertisements presented to user 105A by the i-th publisher 1601, would result in a conversion by user 105A, as illustrated in FIG. 5B.

The attribution engine 320 determines 440 a score of the one or more events excluded from the event chain C₀ based on the probability P(C₀) that event chain C₀ would result in a conversion by user 105A, and the probability P(Cᵢ) that event chain Cᵢ would result in a conversion by user 105A.

For instance, the attribution engine 320 determines a score P*(Cᵢ) based on the difference between probability P(C₀) that event chain C₀ would result in a conversion by user 105A, and the probability P(Cᵢ) that event chain Cᵢ would result in a conversion by user 105A. That is:

P*(Cᵢ)=P(C₀)−P(Cᵢ)

In some embodiments, the attribution engine 320 normalizes the score P*(Cᵢ). For instance, a normalized score P*(Cᵢ) may be:

$${P}^{*} ( {C}_{i} ) = \frac{1}{{\sum }_{k = 1}^{n} ( P ( {C}_{0} ) - P ( {C}_{k} ) )} ( P ( {C}_{0} ) - P ( {C}_{i} ) )$$

The attribution engine 320 attributes 450 a portion of the credit for the conversion across the events/impressions or otherwise determines an attribution amount based on the score P*(Cᵢ). Attribution is assigned to the advertisement impression or the publishers for presenting advertisement impressions to users that purchase the product associated with the advertisement impressions.

In the example of FIG. 5A, the attribution module 235 receives an event chain C₀ with n events E₁ through Eₙ, and the conversion prediction module 310 determines a probability P(C₀) that event chain C₀ would result in a conversion by user 105A. The conversion prediction module 310 determines a probability P(Cᵢ) that event chain Cᵢ would result in a conversion. As illustrated in FIG. 5A, event chain Cᵢ includes the events of event chain C₀, except for event Eᵢ. That is, event chain Cᵢ includes events C₁ through C₍ᵢ₋₁₎ and events C₍ᵢ₊₁₎ through Cₙ. In some embodiments, the conversion prediction module 310 determines probabilities for every event chain C₁ through Cₙ.

The attribution engine 320 determines a score P*(Cᵢ) based on the determined probabilities P(C0) and P(Ci). The attribution engine 320 determines an attribution amount to assign to the advertisement impression associated with event Eᵢ based on the determined score. In some embodiments, an attribution amount to assign to a publisher is determined based on the scores P*(Cᵢ) for every event associated with the publisher.

In the example of FIG. 5B, the attribution module 235 receives an event chain C₀ with n events E₁ through Eₙ. In this example, event E₁ is associated with client device D₁ and publisher P₁, event E₂ is associated with client device D₂ and publisher P₁, event E₃ is associated with client device D₁ and publisher P₂, event E₄ is associated with client device D₁ and publisher P₃, event E₍ₙ₋₁₎ is associated with client device D₂ and publisher P₃, and event Eₙ is associated with client device D₁ and publisher P₂.

The conversion prediction module 310 determines the probability P(C₀) that event chain C₀ would result in a conversion. To determine the attribution amount for the impression associated with publisher P₁, the conversion prediction module 310 determines the probability P(C₁) that event chain C₁, which includes the events of event chain C₀, except for the events associated with publisher P₁ (e.g., events E₁ and E₂). The attribution engine 320 determines a score P*(C₁) based on the determined probabilities P(C₀) and P(C₁). Similarly, the attribution engine 320 determines an attribution amount for the impression by publisher P₂ based on the probability P(C₂) that event chain C₂, which includes the events of event chain C₀, except for the events associated with publisher P₂ (e.g., events E₃ and Eₙ); and determines an attribution amount for the impression associated with publisher P₃ based on the probability P(C₃) that event chain C₃, which includes the events of event chain C₀, except for the events associated with publisher P₃ (e.g., E₄ and E₍ₙ₋₁₎).

Another way to look at how this type of multi-touch attribution model can operate is that the advertising system 160 applies an attribution model to determine a weight for each ad impression in the FIG. 5A or 5B sample event chains C₀ that include n events E₁, E₂, E₃, E₄, . . . , E₍ₙ₋₁₎, Eₙ (each event being an impression of the user for an ad). The weights represent a fractional credit that each impression/event receives for the conversion (e.g., the action taken by the user related to the ad, such as the purchase of an advertised product or service, or the taking of some other action promoted in the ad) according to the attribution model. To obtain the weights for each impression, the trained model of the conversion prediction module 310 predicts the probability P(C₀) that event chain C₀ will result in a conversion. In some embodiments, it does this first based on all of the impressions in the event chain C₀ and then based on all impressions except the one for which the weight is being determined, where the difference between these two calculations gives the relative value for the weight, and the relative values can then be normalized such that the weights sum to 100%. Some events may contribute to the conversion and some may not, so the advertising system 160 parcels out the credit for the conversion across the impressions, thus allowing an advertiser to determine how to attribute each impression to the conversion event. If certain publishers or advertising channels (e.g., search ads, display ads, etc.) are more effective than others in producing conversions, the advertiser can modify his advertising campaign accordingly to focus on the most effective publishers/channels.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving information about an event chain that resulted in a conversion for a user, the event chain including a plurality of events that each represent different advertising impressions of the user;
determining, based on a model, a probability that the event chain would result in a conversion;
determining based on the model, a probability that a second event chain would result in a conversion, the second event chain including the plurality of events of the event chain except for a target event;
determining a score for the target event based on the probability that the event chain would result in a conversion and the probability that the second event chain would result in a conversion; and
attributing a portion of credit for the conversion of the user to the target event based on the determined score.

2. The method of claim 1, wherein the different advertising impressions are presented to the user via a plurality of user devices associated with a user account of an online system.

3. The method of claim 1, wherein the probability that an event chain would result in a conversion is based on at least one of a group consisting of: a type of client device associated with each of the events, a timestamp associated with each of the events, and a type of advertisement associated with each of the events.

4. The method of claim 3, wherein the probability that an event chain would result in a conversion is further based on characteristics of the user.

5. A method comprising:
receiving information about an event chain that resulted in a conversion for a user, the event chain including a plurality of events that each represent different advertising impressions of the user;
determining, based on a model, a probability that the event chain would result in a conversion;
determining based on the model, a probability that a second event chain would result in a conversion, the second event chain including a subset of the plurality of events of the event chain; and
determining a score based on the probability that the event chain would result in a conversion and the probability that the second event chain would result in a conversion.

6. The method of claim 5, wherein determining the score comprises determining a difference between the probability that the event chain would result in a conversion and the probability that the second event chain would result in a conversion.

7. The method of claim 6, wherein determining the score further comprises normalizing the determined difference.

8. The method of claim 5, wherein a conversion is a purchase by the user of a product advertised by the advertisement impressions presented to the user.

9. The method of claim 5, wherein the probability that an event chain would result in a conversion is based on a type of client device associated with each of the events, a timestamp associated with each of the events, and a type of advertisement associated with each of the events.

10. The method of claim 9, wherein the probability that an event chain would result in a conversion is further based on characteristics of the user.

11. The method of claim 5, wherein events of the event chain are advertisement impressions presented to the user via a plurality of client devices.

12. The method of claim 11, wherein the events are advertisement impressions presented to the user for a product presented via a plurality of client devices associated with a user account.

13. The method of claim 5, further comprising:
selecting a target event from the plurality of events of the event chain; and
wherein the second event chain includes each of the plurality of events of the event chain except for the selected target event.

14. The method of claim 13, further comprising:
attributing a portion of credit for the conversion of the user to the target event based on the determined score.

15. The method of claim 5, further comprising:
selecting a target publisher from the plurality of publishers that presented the advertisement impressions to the user; and
wherein the second event chain includes each of the plurality of events of the event chain except for events associated with advertisement impressions presented to the user by the target publisher.

16. The method of claim 15, further comprising:
attributing a portion of credit for the conversion to the target publisher based in part on the determined score.

17. A non-transitory computer-readable storage medium storing computer executable instructions, the instructions when executed by a processor cause the processor to:
receive information about an event chain that resulted in a conversion for a user, the event chain including a plurality of events that each represent different advertising impressions of the user;
determine, based on a model, a probability that the event chain would result in a conversion;
determine based on the model, a probability that a second event chain would result in a conversion, the second event chain including a subset of the plurality of events of the event chain; and
determine a score based on the probability that the event chain would result in a conversion and the probability that the second event chain would result in a conversion.

18. The computer-readable storage medium of claim 17, wherein the instructions for determining the score cause the processor to determine a difference between the probability that the event chain would result in a conversion and the probability that the second event chain would result in a conversion.

19. The computer-readable storage medium of claim 17, wherein a conversion is a purchase by the user of a product advertised by the advertisement impressions presented to the user.

20. The computer-readable storage medium of claim 17, wherein the probability that an event chain would result in a conversion is based on at least one from a group consisting of: a type of client device associated with each of the events, a timestamp associated with each of the events, a type of advertisement associated with each of the events, and characteristics of the user.

21. The computer-readable storage medium of claim 20, wherein the events are advertisement impressions presented to the user for a product presented via a plurality of client devices associated with a user account.

22. The computer-readable storage medium of claim 17, further comprising instruction that when executed by the processor cause the processor to:
select a target event from the plurality of events of the event chain; and
wherein the second event chain includes each of the plurality of events of the event chain except for the selected target event.

23. The computer-readable storage medium of claim 22, further comprising instruction that when executed by the processor cause the processor to:
attributing a portion of credit for the conversion of the user to the target event based in part on the determined score.

24. The computer-readable storage medium of claim 17, further comprising instruction that when executed by the processor cause the processor to:
select a target publisher from the plurality of publishers that presented the advertisement impressions to the user; and
wherein the second event chain includes each of the plurality of events of the event chain except for events associated with advertisement impressions presented to the user by the target publisher.

25. The computer-readable storage medium of claim 24, further comprising instruction that when executed by the processor cause the processor to:
attributing a portion of credit for the conversion of the user to the target publisher based in part on the determined score.
